(19) United States
(12) Patent Application Publication
(10) Pub. No.: US 2011/0214947 A1
(43) Pub. Date: Sep. 8, 2011

(54) LUBRICATION SYSTEM FOR A VEHICLE TRANSMISSION

(75) Inventor: Roger TUOMAS, Torino (SE)

(73) Assignee: GM GLOBAL TECHNOLOGY OPERATIONS, INC., Detroit, MI (US)

(21) Appl. No.: 12/941,865

(22) Filed: Nov. 8, 2010

(30) Foreign Application Priority Data
Nov. 10, 2009 (DE) 102009052595.5

(51) Int. Cl. F16H 57/04

(52) U.S. Cl. 184/6.12

(57) ABSTRACT

A lubrication system is provided for a vehicle transmission having shaft bearings, gearwheel hub bearings, gear rings of interlocking gear shift gearwheel pairs, and rotationally-fixed, axially-displaceable mounts of synchronous clutch elements. The lubricant is kept in a loop, which is supported by gravity and lubricant guide components. For a first, a second, and a third lubrication area, a first, a second, and a third lubricant passage, respectively, are provided, having drip openings to the respective lubrication areas situated underneath. A crown wheel protrudes into a lower lubricant collection volume, and a lubricant guide channel extends from an outer circumference of the crown wheel to an upper lubricant collection volume

### CROSS-REFERENCE TO RELATED APPLICATION

This application claims priority to German Patent Application No. 102009052595.5, filed Nov. 10, 2009, which is incorporated herein by reference in its entirety.

### TECHNICAL FIELD

The invention relates to a lubrication system for a vehicle transmission having shaft bearings, gearwheel hub bearings, gear rings of interlocking gear shift gearwheel pairs, and rotationally-fixed, axially-displaceable mounts of synchronous clutch elements. The lubricant is kept in a loop which is supported by gravity and lubricant guide components.

### BACKGROUND

A lubrication system for a vehicle transmission is known from the publication U.S. Pat. No. 7,513,172 B2 and comprises a transmission housing having shafts situated therein, a rotation part, which is situated in an end section of the housing, ensuring lubricant oil loop. The rotation part is designed so that it lifts lubricant oil to transport the lubricant oil to an area which is spaced apart from the end section inside the housing. An oil passage is provided along the axial direction of the shafts in the transmission housing for this purpose. The oil passage is constructed to receive the lubricant oil which was lifted by the rotation part and to transport the lubricant oil in the longitudinal direction of the oil passage to a second forward end of the transmission housing in the longitudinal direction to an area inside the housing, which is far away from the rotation part. The oil passage is integrally formed with the housing.

FIG. 7 shows a schematic cross-section through such a transmission 60 according to the prior art, whose transmission housing 47 comprises three parts, a forward first part 63 and a second part 64, which together already have the complete function of the transmission having shaft bearings 4 to 9, gearwheel hub bearings 10 to 15, gear rings 16 to 27, and gear shift gearwheel pairs 29 to 34, three synchronous clutch elements 35, 36, and 37 allowing the shifting of the individual gears.

A third part 65 is flanged onto this complete, fully functional vehicle transmission 60 having a total of six gears, including reverse gear. The third part 65 corresponds in its longitudinal extension to at least one of the two first housing sections 63 or 64. This third housing part only contains a crown wheel 50, which is driven via a bevel gear pinion 66. The bevel gear pinion 66 is situated on an end of a lower transmission hollow shaft 52 and protrudes into the third housing part 65. The crown wheel 50 essentially determines the large longitudinal extension of the third housing part 65 by its diameter, which corresponds to the clearance of the vehicle transmission 60.

The outer circumference 48 of the crown wheel 50 is immersed in a lubricant sump or a lower lubricant collection volume 49 and the crown wheel rotates in the arrow direction A. The lubricant oil is carried out of the lower lubricant collection volume 49 and transported into an upper lubricant passage 44, so that the lubricant oil is transported in the upper lubricant passage 44 in the arrow direction B up into the forward first housing part 63. In addition, the passage has drip openings (not shown here), via which the area of the transmission, which lies below the lubricant passage, having its upper transmission hollow shaft 54 and its lower transmission hollow shaft 52, is supplied with lubricant oil.

The lubricant is thus guided in a loop 38 in the arrow direction C and supplied in the lower area of the transmission in the arrow directions D and E to the lower lubricant collection volume 49 in the third housing section 65. In addition, the hollow shafts 52 and 54 have radial supply holes 56 to the shaft bearings 4 to 9 and radial supply holes 55 to the hub bearings 10 to 15 of the gearwheels.

Such a lubrication system 2 having such a complex crown wheel 50 has the disadvantage that the vehicle transmission 60 must be lengthened by more than half of one transmission length in order to ensure the lubrication system. This means a high manufacturing and cost expenditure, as well as a high space requirement, which is often unavailable in the engine compartment of a vehicle.

At least one object of the invention is therefore to specify a lubrication system, which is designed significantly more compactly and effectively and does not substantially increase the overall length of the transmission to be lubricated. In addition, other objects, desirable features, and characteristics will become apparent from the subsequent summary and detailed description, and the appended claims, taken in conjunction with the accompanying drawings and this background.

### SUMMARY

According to an embodiment of the invention, a lubrication system is provided for a vehicle transmission having shaft bearings, gearwheel hub bearings, gear rings of interlocking gear shift gearwheel pairs, and rotationally-fixed, axially-displaceable mounts of synchronous clutch elements. The lubricant is kept in a loop which is supported by gravity and lubricant guide components. For a first, a second, and a third lubrication area, a first, a second, and a third lubricant passage, respectively, having drip openings to the respective lubrication areas situated underneath are provided. A crown wheel protrudes into a lower lubricant collection volume, and a lubricant guide channel extends from an outer circumference of the crown wheel to an upper lubricant collection volume.

Such a lubrication system for a vehicle transmission has the advantage that the required crown wheel can have a significantly reduced diameter in relation to the prior art, since the lubricant is spun via the outer circumference of the crown wheel into a lubricant guide channel. The lubricant guide channel overcomes the further height difference from the outer circumference of the crown wheel up to an upper lubricant passage. Because of the lubricant guide channel, the crown wheel can thus have a significantly smaller diameter.

In addition, the crown wheel can be coupled to the lower hollow shaft of the transmission, without requiring an additional bevel gear, since it is preferably oriented parallel to the transmission gearwheel pairs, in contrast to the prior art. The crown wheel is also situated on an end section of the transmission housing, but it does not rotate transversely to the transmission shafts, so that the transmission housing lengthening can be kept to a minimum, namely to the thickness of the crown wheel, and does not require a housing lengthening, which practically corresponds in its longitudinal extension to the outer diameter of the crown wheel, as in the prior art.

In addition, the crown wheel can be made smaller and lighter, since the lubricant guide channel according to an embodiment of the invention receives the lubricant from the outer circumference of the crown wheel and guides the lubricant up into the uppermost area of the transmission housing. Multiple lubricant passages may thus now be supplied from above from one upper lubricant collection volume. The lubricant can be transported and distributed directly via corresponding drip openings in the lubricant passage into the various areas of the transmission, which are situated below the lubricant passage. In addition to the first upper lubricant passage, a laterally offset second lubricant passage is also connected to the upper lubricant collection volume. In addition, it is possible that the lubricant guide channel supplies an upper transmission hollow shaft with lubricant, the upper transmission hollow shaft having radial supply holes to shaft and hub bearings.

Through the positioning of lubricant holes in the housing walls, in a further embodiment of the invention, the hollow shafts of the transmission may be supplied with lubricants. For this purpose, a first lubricant hole is situated in the transmission housing, which is connected to the upper lubricant collection volume and supplies the third lower lubricant passage with lubricant. A connection is thus provided between the upper lubricant collection volume and the lower lubricant passage via this additional lubricant hole, which is situated in the transmission housing without requiring additional space. This acts in a space-saving and cost-effective manner on the overall concept of the lubrication system for a vehicle transmission according to an embodiment of the invention.

Furthermore, it is provided that a second lubricant hole is situated in the transmission housing, which is connected to the upper lubricant collection volume and supplies a lower transmission hollow shaft with lubricant, the lower transmission hollow shaft having radial supply holes to shaft and hub bearings. With this further embodiment of the invention, the lower areas of the vehicle transmission are connected to the upper lubricant collection volume and the lubricant loop, so that all areas of the transmission are now supplied directly and reliably with lubricant.

In order to throttle the lubricant transport through the crown wheel, in a further embodiment of the invention, a throttle plate is additionally situated in the lower lubricant collection volume. Such a throttle plate ensures that only a partial area of the lower lubricant collection volume is made available to the crown wheel for the further transport in the lubricant loop.

Such a lubrication system is preferably used for a vehicle transmission and has a preferred application as a lubrication system in motor vehicle transmissions. Existing cavities of the conventional transmission are used for the design of the three provided lubricant passages, so that no additional space requirement arises for the three lubricant passages. An additional space requirement only arises due to the thickness of the crown wheel and the lubricant guide channel adjoining the crown wheel. However, this additional transmission volume can also be shrunk significantly in relation to the known prior art because of the novel orientation of the crown wheel, namely transversely to the transmission shafts.

### BRIEF DESCRIPTION OF THE DRAWINGS

The present invention will hereinafter be described in conjunction with the following drawing figures, wherein like numerals denote like elements, and.

FIG. 1 shows a schematic perspective, partially cutaway view of a vehicle transmission having lubrication system according to an embodiment of the invention;

FIG. 2 shows a schematic perspective view of the spatial configuration of lubricant guiding components of a lubricant loop in a vehicle transmission according to FIG. 1;

FIG. 3 shows a schematic perspective view of the spatial configuration of a lubricant guide channel and an upper lubricant collection volume having connected first lubricant passage;

FIG. 4 shows a schematic perspective view of the second lubricant passage;

FIG. 5 shows a schematic perspective view of the third lubricant passage;

FIG. 6 shows a schematic perspective view of the throttle plate in the lower lubricant collection volume; and

FIG. 7 shows a schematic cross-section through a vehicle transmission having a lubrication system according to the prior art.

### DETAILED DESCRIPTION

The following detailed description is merely exemplary in nature and is not intended to limit application and uses. Furthermore, there is no intention to be bound by any theory presented in the preceding background or summary or the following detailed description.

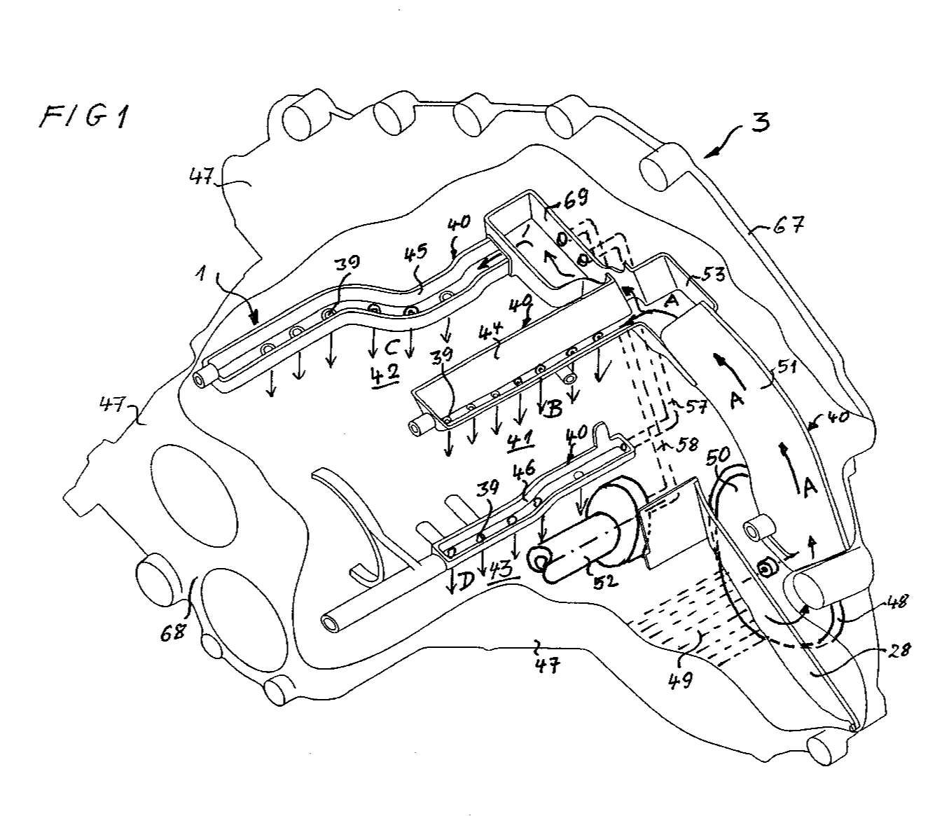

FIG. 1 shows a schematic perspective, partially cutaway view of a vehicle transmission 3 having lubrication system 1 according to one embodiment of the invention. Of the vehicle transmission 3, only the outlines of the transmission housing 47 are shown, as well as a plurality of lubricant guide components 40, which ensure that a lubricant is transported from a lower lubricant collection volume 49 into an upper lubricant collection volume 53 via a lubricant guide channel 51. The various transmission shafts and transmission gearwheels are supplied with lubricant from the upper lubricant collection volume 53 with the aid of gravity and flow velocity of the lubricant.

Of the transmission housing 47, the contour of a transmission housing flange 67 is shown, which can be flanged onto a corresponding clutch. A crown wheel 50 having a relatively small external diameter is immersed in the lower lubricant collection volume 49 and transports or spins, using its outer circumference 48, the lubricant from the lower lubricant collection volume 49 in the arrow direction A through a lubricant guide channel 51 to the upper lubricant collection volume 53. An upper first lubricant passage 44, which can supply an upper area 41 of the transmission 3 situated beneath it with lubricant via corresponding drip openings 39 in the arrow direction B, is connected to the upper lubricant collection volume 53.

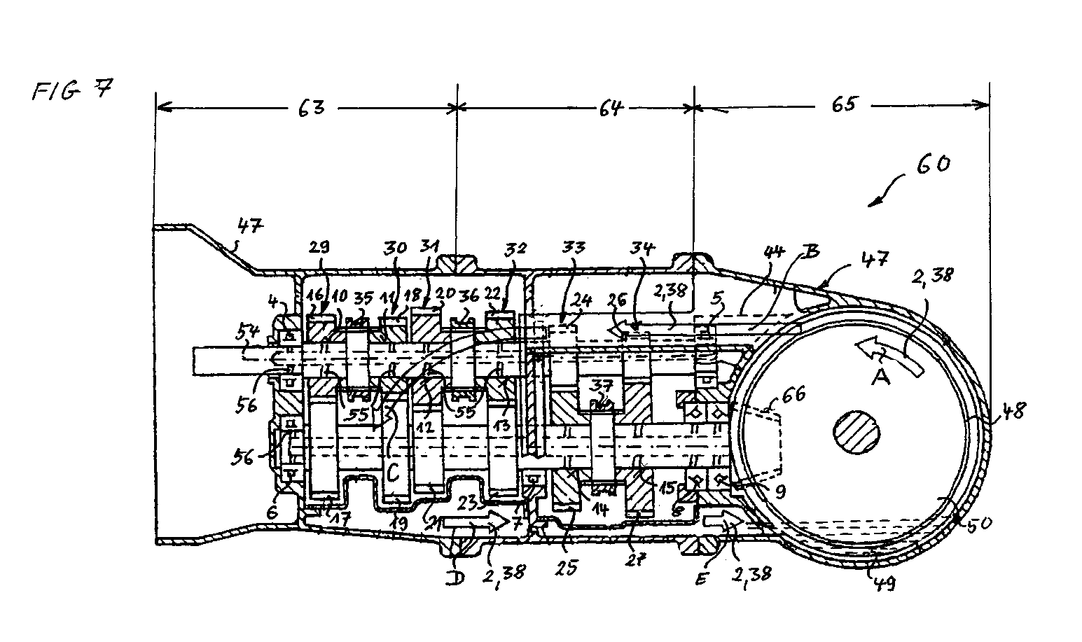

Laterally offset to the upper first lubricant passage 44, a second lubricant passage 45 is connected to the upper lubricant collection volume 53 via a lubricant distributor 69. The second lubricant passage 45 supplies an area 42 of the transmission 3 situated underneath it with lubricant via corresponding drip openings 39 in the specified arrow directions C. In this lubrication system 1 according to the invention, it is noteworthy that sufficient lubricant can be kept in the loop 38 using a relatively small crown wheel 50, whose diameter is significantly smaller than the diameter in the prior art according to FIG. 7, to accordingly supply shaft bearings, gearwheel hub bearings, gear rings, and synchronous clutch elements with sufficient lubricant.

In order to ensure that sufficient lubricant is available in the lower area 43 of the transmission 3, lubricant holes 57 for supplying a lower lubricant passage 46 and a further lubricant hole 58 for supplying a lower transmission hollow shaft 52 are situated in the transmission housing wall. The lubricant holes 57 and 58 are indicated by dashed lines and connect the upper lubricant collection volume 53 via the lubricant distributor 69 to the lower third lubricant passage 46 or the lower transmission hollow shaft 52, respectively. The transmission shafts are implemented as hollow shafts in this embodiment of the invention, as in the prior art corresponding to that shown in FIG. 7, which have radial lubricant distribution holes, to supply hub bearings and shaft bearings with lubricant.

A characterizing feature of this lubrication system 1 according to an embodiment of the invention is a relatively small crown wheel 50, using which the loop 38 of the lubrication is kept moving. This crown wheel 50 rotates parallel to the transmission gearwheel pairs, in contrast to the prior art, and is situated toward the clutch on the transmission housing flange 67 and not positioned on the diametrically opposing end 68 of the transmission housing 47, in contrast to the prior art. The diametrically opposing end 68 of the transmission housing 47 has so-called automatic oilers, as are shown in the following figure, which may be situated on ends of transmission shafts and may distribute lubricant in the transmission volume there from.

In addition, a throttle plate 28 is situated in the lower lubricant collection volume 49, which throttles the inflow of lubricant to the crown wheel 50 to a reasonable amount, so that sufficient lubricant can always be provided for the lubricant loop 38, without the lower lubricant collection volume being run dry by the crown wheel.

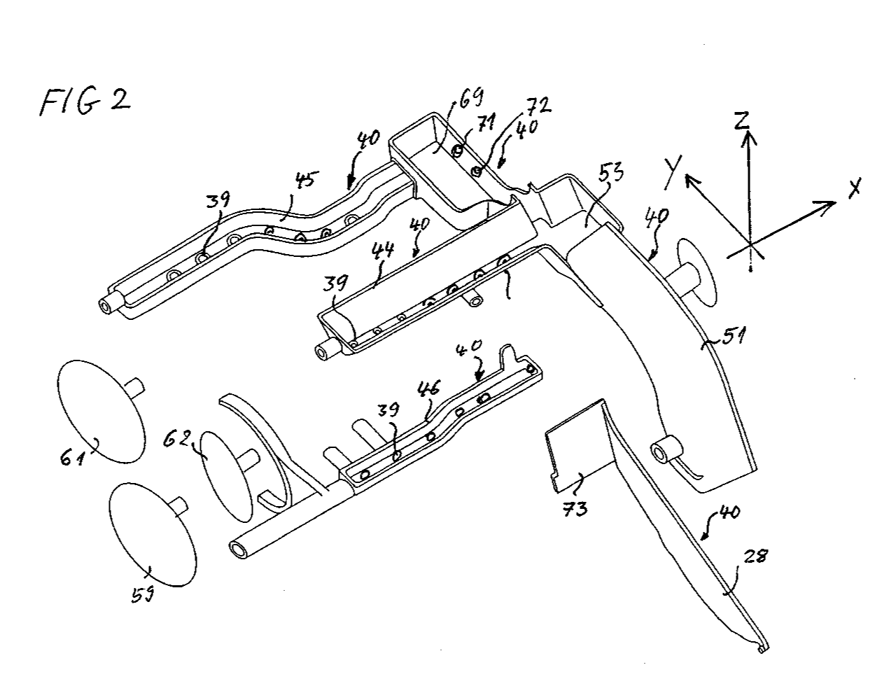

FIG. 2 shows a schematic perspective view of the spatial configuration of lubricant guide components 40 of a lubricant loop 38 in a vehicle transmission 3 according to FIG. 1. Components having identical functions as in FIG. 1 are identified by identical reference numerals and are not explained separately. A coordinate system having x, y, and z axes is incorporated in FIG. 2 as an orientation aid for the spatial configuration, the z axis showing the configuration of the lubricant guide components 40 with respect to the height in the transmission and the x axis being situated in the longitudinal direction of the hollow shafts, while the y axis shows the transverse direction in the transmission 3.

In addition, the illustration of the crown wheel, as shown in FIG. 1, was dispensed with. For this purpose, the throttle plate 28 is visible at the lowest point of the transmission 3 in the area of the lower lubricant collection volume. The function of the throttle valve was already explained in the introduction with FIG. 1, so that a repetition is superfluous here. The lubricant guide channel 51, in which the lubricant is guided to the upper lubricant collection volume 53 and is distributed from there to the upper lubricant passage 44 and a laterally offset second lubricant passage 45, is situated above the throttle plate 28 and above the crown wheel (not shown here).

As already explained in FIG. 1, the lower areas of the transmission are supplied by a lower third lubricant passage 46, each of the lubricant passages 44 to 46 having drip openings 39, via which the lubricant areas situated below the lubricant passages are supplied. In addition to the lubricant passages, so-called automatic oilers 59, 61, and 62 are situated on the diametrically opposite end to the transmission input flange and are connected to end areas of the transmission shafts, which ensure that the remaining lubricant is distributed uniformly in this area of the transmission.

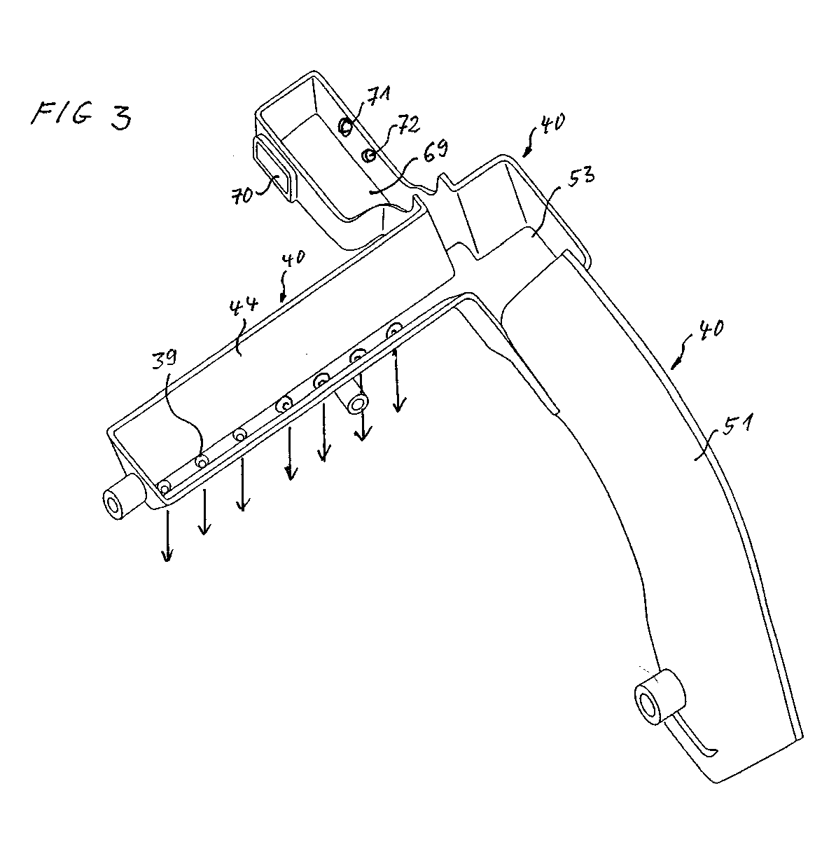

FIG. 3 shows a schematic perspective view of the spatial configuration of a lubricant guide channel 51 and an upper lubricant collection volume 53 having connected first lubricant passage 44. The upper lubricant collection volume 53 not only supplies the upper lubricant passage 44 but rather also a lubricant distributor 69, onto which a second laterally offset lubricant passage can be flanged. This lubricant distributor 69 has, in addition to an opening 70 for this second laterally offset lubricant passage, further openings 71 and 72, which are connected to lubricant holes in the housing wall, to supply lower areas of the transmission 3 with lubricant.

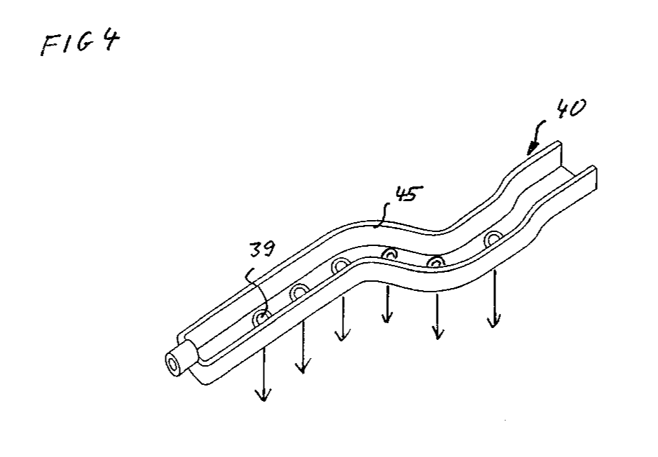

FIG. 4 shows a schematic perspective view of the second lubricant passage 45 in detail, which can be flanged onto the opening 70 of the lubricant distributor 69 shown in FIG. 3 or inserted into this opening 70. This lubricant passage is also provided with corresponding drip openings 39, through which the lubricant can drip into a lubricant area, which is situated below the lubricant passage 45.

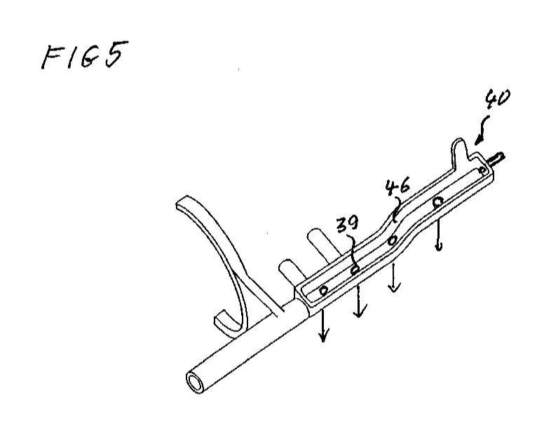

FIG. 5 shows a schematic perspective view of the third lubricant passage 46, which is connected via a lubricant hole in the housing wall to the lubricant distributor 69, which is shown in FIG. 3.

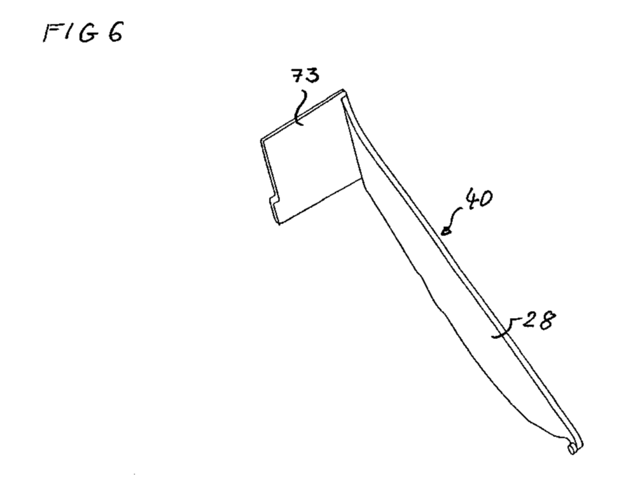

FIG. 6 shows a schematic perspective view of the throttle plate 28 as a lubricant guide component 40, which is immersed in the lower lubricant collection volume and throttles the supply of lubricant to the crown wheel (not shown). The throttle plate 28 merges into an angled plate, which is used as a fastening flange 73 for the throttle plate 28 within the transmission housing.

FIG. 7 shows a schematic cross-section through a vehicle transmission 60 having a lubrication system 2 according to the prior art, as was already explained at the beginning, so that a further explanation is superfluous.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A lubrication system for a vehicle transmission, comprising:
a loop adapted to keep a lubricant that is supported by gravity;
lubricant guide components adapted to further support the loop;
a first lubricant passage for a first lubricant area;
a second lubricant passage for a second lubricant area;
a third lubricant passage for a third lubricant area;
a first drip opening for the first lubricant passage situated underneath the first lubricant area;
a second drip opening for the second lubricant passage situated underneath the second lubricant area;
a third drip opening for the third lubricant passage situated underneath the third lubricant area;
a crown wheel adapted to protrude into a lower collection volume for the lubricant; and
a lubricant guide channel adapted to extend from an outer circumference of the crown wheel to an upper collection volume of the lubricant.

2. The lubrication system according to claim 1, wherein the lubricant guide channel is adapted to supply an upper transmission hollow shaft with the lubricant, the upper transmission hollow shaft comprising radial supply holes to a shaft and hub bearings.

3. The lubrication system according to claim 1, wherein the first lubricant passage and the second lubricant passage are laterally offset and connected to the upper collection volume.

4. The lubrication system according to claim 1, wherein a first lubrication hole is situated in a transmission housing that is connected to the upper collection volume and adapted to supply the third lubricant passage with the lubricant.

5. The lubrication system according to claim 1, wherein a second lubricant hole is situated in a transmission housing that is connected to the upper collection volume and adapted to supply a lower transmission hollow shaft with the lubricant, the lower transmission hollow shaft comprising radial supply holes to a shaft and hub bearings.

6. The lubrication system according to claim 1, further comprising a throttle plate situated in the lower collection volume and adapted to throttle a transport of the lubricant of the crown wheel.

7. A motor vehicle transmission, comprising:
shaft bearings;
gearwheel hub bearings;
gear rings of interlocking gear shift gearwheel pairs, and rotationally-fixed and axially-displaceable mounts of a synchronous clutch element; and
a lubrication system for at least one of the shaft bearings, the gearwheel hub bearings, the gear rings of the interlocking gear shift gearwheel pairs, or the rotationally-fixed and axially-displaceable mounts of the synchronous clutch element, the lubrication system comprising:
a loop adapted to keep a lubricant that is supported by gravity;
lubricant guide components adapted to further support the loop;
a first lubricant passage for a first lubricant area;
a second lubricant passage for a second lubricant area;
a third lubricant passage for a third lubricant area;
a first drip opening for the first lubricant passage situated underneath the first lubricant area;
a second drip opening for the second lubricant passage situated underneath the second lubricant area;
a third drip opening for the third lubricant passage situated underneath the third lubricant area;
a crown wheel adapted to protrude into a lower collection volume for the lubricant; and
a lubricant guide channel adapted to extend from an outer circumference of the crown wheel to an upper collection volume of the lubricant.

8. The motor vehicle transmission according to claim 7, wherein the lubricant guide channel is adapted to supply an upper transmission hollow shaft with the lubricant, the upper transmission hollow shaft comprising radial supply holes to a shaft and hub bearings.

9. The motor vehicle transmission according to claim 7, wherein the first lubricant passage and the second lubricant passage are laterally offset and connected to the upper collection volume.

10. The motor vehicle transmission according to claim 7, wherein a first lubrication hole is situated in a transmission housing that is connected to the upper collection volume and adapted to supply the third lubricant passage with the lubricant.

11. The motor vehicle transmission according to claim 7, wherein a second lubricant hole is situated in a transmission housing that is connected to the upper collection volume and adapted to supply a lower transmission hollow shaft with the lubricant, the lower transmission hollow shaft comprising radial supply holes to a shaft and hub bearings.

12. The motor vehicle transmission according to claim 7, further comprising a throttle plate situated in the lower collection volume and adapted to throttle a transport of the lubricant of the crown wheel.
